(19) United States
(12) Patent Application Publication
(10) Pub. No.: US 2024/0211449 A1
(43) Pub. Date: Jun. 27, 2024

(54) SYSTEMS AND METHODS FOR DATABASE CONFIGURATION MANAGEMENT

(71) Applicant: Palantir Technologies Inc., Denver, CO (US)

(72) Inventors: Adam Anderson, Minneapolis, MN (US); Joseph Henke, Boulder, CO (US); James Lin, Mountain View, CA (US); Nicholas Miyake, Emerald Hills, CA (US)

(21) Appl. No.: 18/394,405

(22) Filed: Dec. 22, 2023

Related U.S. Application Data
(60) Provisional application No. 63/435,013, filed on Dec. 23, 2022.

(51) Int. Cl. G06F 16/21

(52) U.S. Cl. CPC G06F 16/21

(57) ABSTRACT

Systems and methods for database configuration management are provided. For example, a method for database configuration management comprises: obtaining user input corresponding to a target database state for the database; generating, based on the user input, a target state configuration for the database; determining a current state configuration for the database; generating a set of steps to change the configuration of the database from the current state configuration to the target state configuration; and implementing the set of steps, thereby configuring the database according to the target state configuration.

### CROSS REFERENCE TO RELATED APPLICATIONS

This application claims priority to U.S. Provisional Application No. 63/435,013, filed Dec. 23, 2022, incorporated by reference herein for all purposes.

### TECHNICAL FIELD

Certain embodiments of the present disclosure are directed to systems and methods for database configuration management. More particularly, some embodiments of the present disclosure provide systems and methods for evaluating a current state configuration of a database and generating a set of steps with which to transform the current state configuration of the database to a target state configuration.

### BACKGROUND

In examples, a variety of aspects of a database are configurable, and different configurations may be applicable for different situations and contexts. However, existing technology is unable to manage a potentially large and varied number of database configurations, which can result in inconsistencies across databases, misconfigurations, user frustration, and/or reduced use of database technologies in instances where a database would otherwise be applicable. These and other issues can result in security vulnerabilities, data loss, reduced performance, reduced user satisfaction, and/or compliance issues, among other examples.

Hence it is desirable to provide improved database configuration technologies.

### SUMMARY

Certain embodiments of the present disclosure are directed to systems and methods for database configuration management. More particularly, some embodiments of the present disclosure provide systems and methods for evaluating a current state configuration of a database and generating a set of steps with which to transform the current state configuration of the database to a target state configuration.

In some embodiments, a method for managing a configuration of a database is provided. The method comprises: obtaining user input corresponding to a target database state for the database: generating, based on the user input, a target state configuration for the database: determining a current state configuration for the database: generating a set of steps to change the configuration of the database from the current state configuration to the target state configuration: and implementing the set of steps, thereby configuring the database according to the target state configuration: wherein the method is performed using one or more processors.

In certain embodiments, another method for managing a configuration of a database is provided. The method comprises: obtaining a target database state for the database that includes a general configuration indication: generating a target state configuration for the database based on a pre-defined configuration that corresponds to the general configuration indication: determining a current state configuration for the database: generating a set of steps to change the configuration of the database from the current state configuration to the target state configuration: and implementing the set of steps, thereby configuring the database according to the target state configuration: wherein the method is performed using one or more processors.

In some embodiments, a system for managing a configuration of a database is provided. The system comprises: one or more memories comprising instructions stored thereon: and one or more processors configured to execute the instructions and perform operations comprising: obtaining user input corresponding to a target database state for the database: generating, based on the user input, a target state configuration for the database; determining a current state configuration for the database: generating a set of steps to change the configuration of the database from the current state configuration to the target state configuration: and implementing the set of steps, thereby configuring the database according to the target state configuration.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 illustrates a method for configuring a database to achieve a target state configuration according to certain embodiments of the present disclosure.

FIG. 2 illustrates a method for configuring a database to achieve a target database state according to certain embodiments of the present disclosure.

FIG. 3 illustrates a method 300 for updating the configuration of a database to achieve an updated target database state according to certain embodiments of the present disclosure.

FIG. 4 illustrates a method for migrating a database from a first configuration to a second configuration according to certain embodiments of the present disclosure.

FIG. 5 illustrates an example system in which aspects of the present disclosure may be practiced.

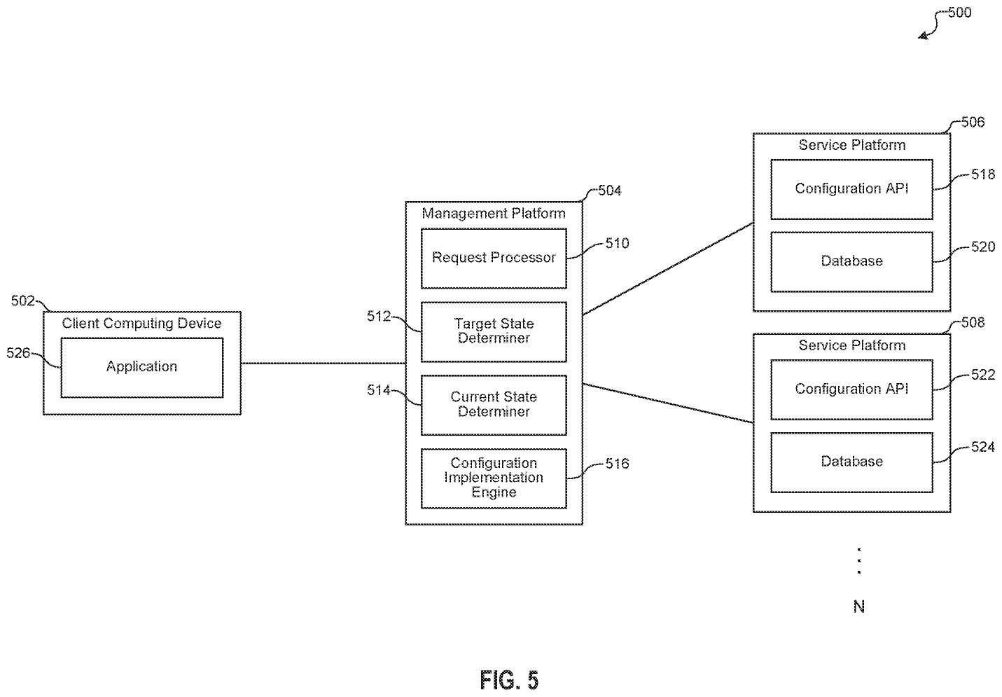

FIG. 6 is a simplified diagram showing a computing system for implementing aspects of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

According to some embodiments, the systems and methods for database configuration management use a current state determiner, a target state determiner, and a configuration implementation engine to manage the configuration of one or more databases. For example, a database can include a relational database (e.g., with tables, rows, and columns) or a graph database (e.g., with nodes, edges, and corresponding properties) and, additionally, or alternatively, can include a cloud storage instance. In an example, a current state configuration of a database is determined and compared to a target state configuration to generate a set of steps with which to transform the current state configuration of the database to the target state configuration. For example, the target state configuration is obtained from a user or is generated based on a more general target database state (e.g., as may be defined by one or more general configuration indications), among other examples.

In certain examples, the set of steps with which a database configuration is transformed is generated based on a set of rules (e.g., that map a given current state configuration to a target state configuration), based on a set of templates (e.g., which may be populated according to a current state configuration and/or a target state configuration), and/or based on a machine learning model (e.g., that processes the current state configuration to generate a set of steps that implements the target state configuration), among other examples. Further, such rules, templates, and/or processing by a machine learning model need not be static and, in some examples, new states (e.g., relating to a current state configuration and/or a target state configuration) are learned or otherwise determined, thereby enabling transformations between states that may have otherwise not been possible. Similarly, according to some examples, a set of steps that is performed to transform a database from a current state configuration to a target state configuration is automatically and/or manually modified (e.g., as a result of determining a server-side change has rendered one or more steps ineffectual or as a result of identifying a more efficient way to achieve the target state configuration).

At least some disclosed aspects generate steps to go from a current state configuration to a target state configuration that are sequenced intentionally to maximize or otherwise increase safety and reduce risk and/or potential downtime. Indeed, in certain embodiments, the complexity of database configuration in general, and especially the complexity of migrating between the current state configuration to the target state configuration, makes it very likely that manual database configuration will introduce human error (e.g., missing a constraint, a dependency, and/or another variable) that causes a manual configuration change to have unintended side effects. By contrast, in some embodiments, the disclosed aspects account for these and other factors when generating steps to transition from the current state configuration to the target state configuration, thereby offering improved reliability and reproducibility, among other benefits.

For example, the disclosed aspects may first determine whether a new version of a database engine or platform has a dependency on a given resource to exist, such that the resource is generated, installed, or otherwise created prior to performing an upgrade of the database engine. Similarly, as an example, if a comparatively dangerous or high-risk operation is being performed, the disclosed aspects may generate a backup of the database and/or current state configuration to provide the ability to rollback one or more changes. Additionally, or alternatively, if it is determined that a database is not in a “safe” state (e.g., the database is unhealthy), such a determination may cause the disclosed aspects to defer certain operations and/or to take corrective action in an effort to remedy the state of the database, for example. These and other aspects, in some embodiments, thus contribute to the reliability and ease of configuration, among other examples, that are enabled by the disclosed aspects.

Once the set of steps has been performed to configure the database according to the target state configuration, the configuration (e.g., the now current state configuration) of the database can be evaluated to verify that the target state configuration has been achieved. In examples, error handling is used to address configuration issues when transforming a database from a current state configuration to a target state configuration and/or after the transformation according to the set of steps has occurred.

As used herein, a user defines a target database state for a database. In examples, the target database state is defined as a target state configuration, which can include one or more “specific configuration indications” that each relate to the target database state. For example, a specific configuration indication includes one or more parameters relating to the database configuration. In other examples, the target database state is defined using one or more “general configuration indications,” which may each have one or more associated specific configuration indications. As an example, a general configuration indication instead indicates a desired database state/requirement (e.g., at a higher level than would be indicated by a database parameter of a specific configuration indication).

For example, rather than including a specific configuration indication that defines a specific size for a database (e.g., as one or more database parameters), a user instead uses a general configuration indication that describes a desired data storage state/requirement (e.g., as may be a selection of a database size from a set of predefined database sizes, such as small, medium, large). Similarly, rather than including a specific configuration indication that defines an encryption key length and/or encryption algorithm, a general configuration indication can be used that instead indicates a general security level (e.g., no security, low security, medium security, high security). In embodiments, a configuration for a database (e.g., as may be defined in a configuration file) thus includes one or more specific configuration indications and/or one or more general configuration indications for a database, where such general configuration indications are processed to generate a set of corresponding specific configuration indications that form at least a part of a target state configuration for the database accordingly.

In examples, different specific configuration indications are used depending on a context for which the database is being configured. For example, one or more specific configuration indications can be associated with a general configuration indication based on one or more compliance rules, company policies, and/or constraints, among other examples. As a result, in certain examples, the same or a substantially similar target database state is specified for databases having different contexts, such that each respective database is configured according to a target state configuration having a different set of specific configuration indications that correspond to the associated context for the database, even though the same or a similar target database state is defined (e.g., by a configuration file). Thus, as a result of such associations between a general configuration indication and one or more specific configuration indications, a user need not be familiar with best practices and/or compliance requirements, as well as idiosyncrasies of a specific database engine and/or platform. The user can thus instead provide one or more general configuration indications that, in examples, have broader applicability across a variety of contexts. Rather, the associated specific configuration indications may have been selected to ensure conformity and/or configuration repeatability across multiple databases, as well as compliance with security and/or data management best practices, among other goals and/or benefits.

As an example, existing technology is unable to manage a potentially large and varied number of database configurations, which can result in inconsistencies across databases, misconfigurations, user frustration, and/or reduced use of database technologies in instances where a database would otherwise be applicable. These and other issues can result in security vulnerabilities, data loss, reduced performance, reduced user satisfaction, and/or compliance issues, among other examples. Additionally, existing solutions can require low-level engine-specific and/or platform-specific knowledge when configuring a database, which can complicate initial database configuration and/or updates to the database configuration in the future. Similarly, in certain examples, such idiosyncrasies make it difficult or impossible to migrate a database from a first configuration/platform to a second configuration/platform. It will be appreciated that these and other deficiencies are addressed by aspects of the present disclosure.

Accordingly, aspects of the present disclosure may perform processing to configure a database according to a target state configuration based on a current state configuration for the database. In examples, a configuration interface with which to manage aspects of the present disclosure includes a configuration file in which a user (e.g., an administrator, a developer, or a project manager) inputs one or more configuration indications. Accordingly, the configuration file is processed to determine a target state configuration for one or more associated databases, which can then be used to transform a database from an associated current state configuration to the target state configuration.

In examples, the disclosed aspects act as an abstraction layer for an associated database engine (e.g., POSTGRES or MYSQL) and/or an associated platform (e.g., AMAZON WEB SERVICES, GOOGLE CLOUD PLATFORM, or MICROSOFT AZURE), thereby enabling a user to specify a target database state for a database without engaging in engine-specific and/or platform-specific configuration of the database. While examples are described in relation to a platform via which a database is hosted or otherwise provide, it will be appreciated that similar aspects can be used in instances where a database is on-premise or otherwise locally hosted, among other examples.

Further, as a result of providing a layer of abstraction between the target database state and the database itself, different configurations can be implemented for different contexts, as described above. According to some examples, the target state configuration that is applied to a database is thus achieved in a repeatable and/or auditable manner as a result of the aspects described herein. Additionally, upgrading the database to an updated or different target database state may be more easily achieved according to aspects of the present disclosure as compared to manually updating one or more potentially varied databases.

In examples, a control loop is used to ensure the database is configured in accordance with a target database state (e.g., as can be defined using a configuration file). As a result, a change to the target database state is processed according to aspects of the present disclosure to transform the current state configuration of the database to a target state configuration corresponding to the updated target database state. For instance, the new target database state includes a change to one or more associated settings, an upgrade, a backup of the database and/or database configuration, a restore of the database and/or database configuration, and/or a database migration, among other examples.

As noted above, in some examples, a user specifies a target database state, for example using a configuration file. It will be appreciated that any of a variety of additional or alternative techniques can be used to obtain a target database state. As another example, a natural language user interface is provided, via which a user converses with a chatbot, conversational agent, or other natural language user interface to provide one or more configuration indications (or, as another example, natural language user input that is used to generate such configuration indications accordingly). Configuration indications that are obtained via the conversational agent may thus be used to form a configuration for the database, such that the database is configured according to the target database state as a result.

While examples of the present disclosure are described in the context of database management, it will be appreciated that similar techniques can be used for managing compute resources (e.g., physical device, virtual machines, and/or containers), as well as storage (e.g., physical storage devices, network-attached storage, and/or virtualized storage), among other examples. Additionally, the disclosed aspects can be used for management of a database schema and/or content therein, in addition to or as an alternative to the management of database settings.

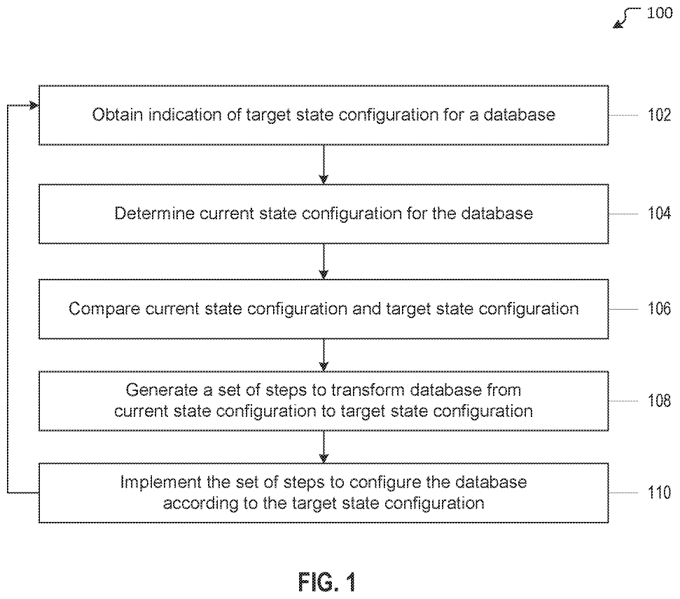

FIG. 1 is a simplified diagram showing an example method 100 for configuring a database to achieve a target state configuration according to certain embodiments of the present disclosure. This diagram is merely an example. One of ordinary skill in the art would recognize many variations, alternatives, and modifications.

As illustrated, at operation 102, an indication of a target state configuration for the database is obtained. As noted above, the target state configuration is obtained from a configuration file in some examples. As another example, the target state configuration is additionally, or alternatively, obtained via a natural language user interface or, in other examples, is based on any of a variety of additional or alternative user input. It will therefore be appreciated that the target state configuration is obtained using any of a variety of techniques according to aspects described herein. As noted above, the target state configuration includes one or more specific configuration indications in some examples.

At operation 104, a current state configuration is determined for the database. In examples, operation 104 comprises querying an application programming interface (API) associated with a database engine and/or a platform to obtain the current configuration state accordingly. In such examples, a response to the query is received that includes one or more engine- and/or platform-specific configuration indications. As another example, operation 104 includes executing one or more commands to obtain such configuration indications accordingly. For example, the one or more commands is selected based on the target state configuration that was obtained at operation 102, such that engine- and/or platform-specific configuration indications corresponding to configuration indications of the target state configuration are obtained.

It will therefore be appreciated that any of a variety of techniques can be used to obtain a current state configuration for a database according to aspects described herein. Additionally, it will be appreciated that the configuration indications that form the target state configuration obtained at operation 102 can be at a different (e.g., higher) level of abstraction as compared to the engine- and/or platform-specific configuration indications that were determined at operation 104, such that they do not necessarily address engine- and/or platform-specific idiosyncrasies that are associated with the database and/or the associated platform.

At operation 106, the current state configuration and the target state configuration are compared, for example to identify one or more differences between the current state configuration and the target state configuration. As noted above, aspects of the present disclosure may thus offer target-based configuration of the database, whereby a user specifies a target database state with which the database is transformed accordingly.

While method 100 is described as an example in which the target state configuration is obtained from a user, such that one or more associated differences are thus the result of a user changing the configuration for the database, it will be appreciated that similar techniques can be used in instances where a target state configuration changes without such user input (e.g., automatically). For instance, a target database state is updated as a result of changes to one or more compliance rules, company policies, and/or constraints and configuration indications associated therewith. Additional examples of such aspects are described in greater detail below:

Flow progresses to operation 108, where a set of steps is generated to transform the database from the current state configuration to the target state configuration (e.g., based on one or more differences that were identified at operation 106). In examples, operation 108 comprises evaluating a set of rules, processing a set of templates, and/or generating one or more steps using a machine learning model, among other examples. The generated set of steps may include one or more steps that are engine- and/or platform-specific (e.g., whereas the target state configuration obtained at operation 102 includes steps that are not). Any of a variety of steps can be generated at operation 108, which, for example, include an API call, a command, and/or a reference to a configuration script, among other examples.

According to some embodiments, the set of rules define or otherwise are associated with a state graph that includes a mapping between a start state, and end state, and one or more steps to transform a database in the start state to the end state. As another example, a template is populated with aspects relating to the current state configuration and/or the target state configuration, thereby generating one or more steps accordingly. In a further example, an indication of the current state configuration and/or the target state configuration is provided to the machine learning model (e.g., which may be a general machine learning model or a machine learning model that was trained according to database configuration indications), such that the machine learning model generates one or more steps accordingly.

According to certain embodiments, the machine learning model may be a language model (“LM”) that includes an algorithm, rule, model, and/or other programmatic instructions that can predict the probability of a sequence of words. In some embodiments, a language model may, given a starting text string (e.g., one or more words), predict the next word in the sequence. In certain embodiments, a language model may calculate the probability of different word combinations based on the patterns learned during training (based on a set of text data from books, articles, websites, audio files, etc.). In some embodiments, a language model may generate many combinations of one or more next words (and/or sentences) that are coherent and contextually relevant. In certain embodiments, a language model can be an advanced artificial intelligence algorithm that has been trained to understand, generate, and manipulate language. In some embodiments, a language model can be useful for natural language processing, including receiving natural language prompts and providing natural language responses based on the text on which the model is trained. In certain embodiments, a language model may include an n-gram, exponential, positional, neural network, and/or other type of model.

According to some embodiments, the general machine learning model may be a large language model (LLM), which was trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like.

In certain embodiments, an indication as to a current state configuration and/or a target state configuration may be provided as part of a prompt to such an LLM, thereby causing the LLM to generate model output relating to a set of steps with which to transform the database state configuration accordingly.

In some examples, a database engine and/or a platform announces, publishes, or otherwise makes available a set of configuration “hints” that are processed according to aspects of the present disclosure to automatically or semi-automatically generate new associations between one or more start and/or end states. It will therefore be appreciated that any of a variety of techniques can be used to generate the set of steps with which the database is to be transformed accordingly.

At operation 110, each step of the set of steps is processed, executed, or otherwise implemented, thereby configuring the database according to the target state configuration. In examples, operation 110 comprises performing error handling for a given step, as may be the case when a step fails due to an unexpected database state and/or due to a change to the database engine and/or platform, among other examples. For example, operation 110 comprises performing a step, determining whether the step was successful, and, if the step was not successful, performing a remedial step accordingly. As another example, operation 110 further comprises verifying the state of the database after the set of steps has been implemented, such that subsequent similar processing is performed in instances where it is determined that the now-current database state does not match the target database state. In examples, method 100 forms part of a control loop, whereby changes to the configuration of the database are implemented by performing aspects of method 100 accordingly.

Although example method 100 has been shown using a selected group of processes, it will be appreciated that there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In certain examples, some or all processes (e.g., steps) of method 100 are performed by a computer and/or a processor directed by a code. For example, a computer includes a server computer and/or a client computer (e.g., a personal computer). In some examples, some or all processes (e.g., steps) of method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

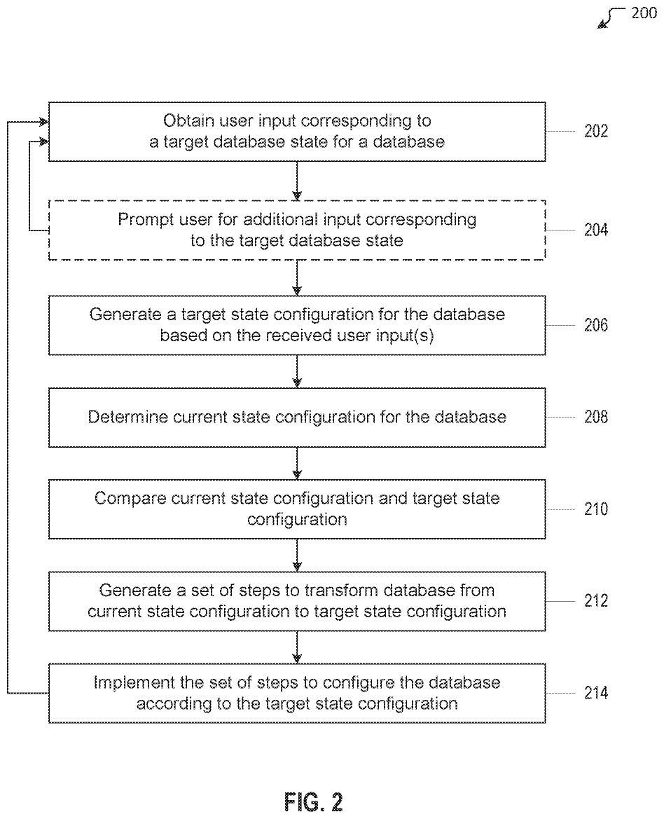

FIG. 2 is a simplified diagram showing an example method 200 for configuring a database to achieve a target database state according to certain embodiments of the present disclosure. This diagram is merely an example. One of ordinary skill in the art would recognize many variations, alternatives, and modifications.

As illustrated, at operation 202, user input corresponding to a target database state for a database is obtained. In examples, the target database state is obtained from a configuration file. As another example, the target database state is obtained via a natural language user interface or, in other examples, based on any of a variety of additional or alternative user input. It will therefore be appreciated that the target database state can be obtained using any of a variety of techniques according to aspects described herein.

As compared to method 100 in which a target state configuration is obtained, the obtained target database state can instead include one or more general configuration indications (in addition to or as an alternative to one or more specific configuration indications that would otherwise form the target state configuration that was obtained in method 100). As noted above, in some examples, each general configuration indication includes one or more associated specific configuration indications, which can be determined based on a context for which the database is being configured, among other examples.

In instances where a natural language user interface is used to obtain the target database state, operation 204 is performed to prompt the user for additional input corresponding to the target database state. For example, operation 204 requests clarification for input that was received at operation 202. As another example, operation 204 additionally, or alternatively, requests user input associated with an additional configuration indication with which to configure the database. As noted above, according to some embodiments, a chatbot, conversational agent, or other natural language user interface is used to engage in a conversation with the user to obtain one or more general configuration indications accordingly. An arrow is illustrated from operation 204 to operation 202 to indicate that, in some examples, method 200 loops between operations 202 and 204 as a user converses with the conversational agent to define the target database state accordingly. Operation 204 is illustrated using a dashed box to indicate that, in other examples, operation 204 is omitted.

Flow progresses to operation 206, where a target state configuration is generated for the database based on the obtained target database state (e.g., as were received from the user at operation 202 and, in some examples, operation 204). As noted above, each general configuration indication of the target database state has one or more associated specific configuration indications in certain examples, which may thus form the target state configuration accordingly. For example, the specific configuration indication(s) is associated with the general configuration indication based on one or more compliance rules, company policies, and/or constraints, among other examples, which corresponds to a context associated with the database.

Thus, as a result of such associations between general configuration indication(s) of the target database state and one or more specific configuration indications, a user (e.g., from which user input was received at operations 202 and/or 204) need not be familiar with best practices and/or compliance requirements, as well as idiosyncrasies of a specific database engine and/or platform. In examples, the associated specific configuration indication(s) may have been selected (e.g., by a database administrator) to ensure conformity and/or configuration repeatability across multiple databases, as well as compliance with security and/or data management best practices, among other goals and/or benefits.

Moving to operation 208, a current state configuration is determined for the database. Aspects of operation 208 may be similar to those discussed above with respect to operation 104 of method 100 in FIG. 1. For example, an API associated with a database engine and/or a platform is queried to obtain the current configuration state accordingly. In such examples, a response to the query is received that includes one or more engine- and/or platform-specific configuration indications. As another example, one or more commands are executed to obtain such configuration indications accordingly. It will therefore be appreciated that any of a variety of techniques can be used to obtain a current state configuration for a database according to aspects described herein. Additionally, the configuration indications that form the target database state may be at a different (e.g., higher) level of abstraction as compared to the engine- and/or platform-specific configuration indications that are determined at operation 208.

At operation 210, the current state configuration and the target state configuration (e.g., as was generated at operation 206) are compared, for example to identify one or more differences between the current state configuration and the target state configuration. Aspects of operation 210 may be similar to those discussed above with respect to operation 106 of method 100 in FIG. 1.

While method 200 is described as an example in which the target database state is obtained from a user, such that one or more associated differences are thus the result of a user changing the configuration for the database, it will be appreciated that similar techniques can be used in instances where a target database state changes without such user input (e.g., automatically). For instance, one or more specific configuration indications that are associated with a general configuration indication are changed in other examples (e.g., as a result of changes to one or more compliance rules, company policies, and/or constraints), such that the target database state is updated accordingly. Additional examples of such aspects are described in greater detail below.

Flow progresses to operation 212, where a set of steps is generated to transform the database from the current state configuration to the target state configuration (e.g., based on one or more differences that were identified at operation 210). Aspects of operation 212 may be similar to those discussed above with respect to operation 108 of method 100 in FIG. 1. For example, a set of rules is evaluated, a set of templates is processed, and/or one or more steps are generated using a machine learning model, among other examples. As noted above, in certain examples, the generated set of steps includes one or more steps that are engine- and/or platform-specific (e.g., whereas the target state configuration generated at operation 206 need not be). Thus, according to some embodiments, a general configuration indication has one or more associated specific configuration indications, each of which is further associated with an engine- and/or platform-specific step with which to configure a database. Any of a variety of steps can be generated at operation 212, which, for example, include an API call, a command, and/or a reference to a configuration script, among other examples.

At operation 214, each step of the set of steps is processed, executed, or otherwise implemented, thereby configuring the database according to the target state configuration. Aspects of operation 214 may be similar to those discussed above with respect to operation 110 of method 100 in FIG. 1. For instance, error handling is performed when implementing a given step and/or after the set of steps has been implemented, among other examples. In examples, method 200 forms part of a control loop, whereby changes to the configuration of the database are implemented by performing aspects of method 200 accordingly.

Although example method 200 has been shown using a selected group of processes, it will be appreciated that there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In certain examples, some or all processes (e.g., steps) of method 200 are performed by a computer and/or a processor directed by a code. For example, a computer includes a server computer and/or a client computer (e.g., a personal computer). In some examples, some or all processes (e.g., steps) of method 200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

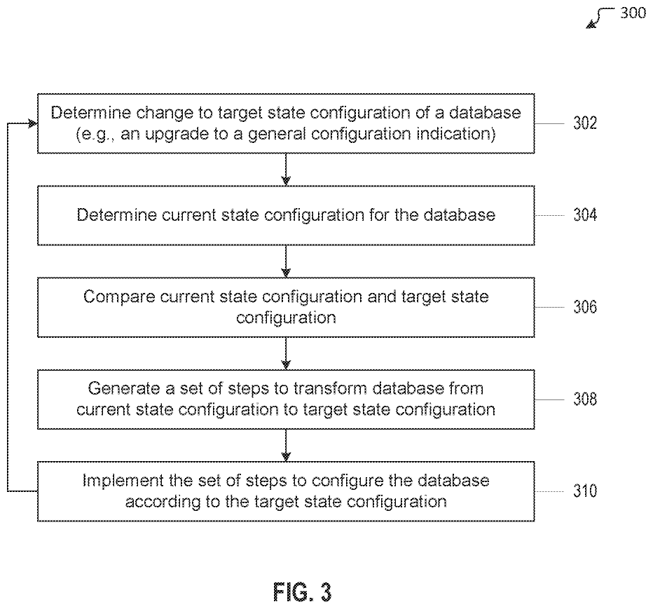

FIG. 3 is a simplified diagram showing an example method 300 for updating the configuration of a database to achieve an updated target database state according to certain embodiments of the present disclosure. This diagram is merely an example. One of ordinary skill in the art would recognize many variations, alternatives, and modifications.

As illustrated, at operation 302, a change to a target state configuration of the database is determined. For example, one or more specific configuration indications associated with a general indication of a target database state may change (e.g., as a result of a database administrator making a change for security, compliance, or resource utilization reasons). Aspects of operation 302 may be similar to those discussed above with respect to operation 102 of method 100 and/or operations 202-206 of method 200, where the target state configuration is associated with a target database state for the database. For instance, the target state configuration may have been generated based on the target database state according to aspects described herein.

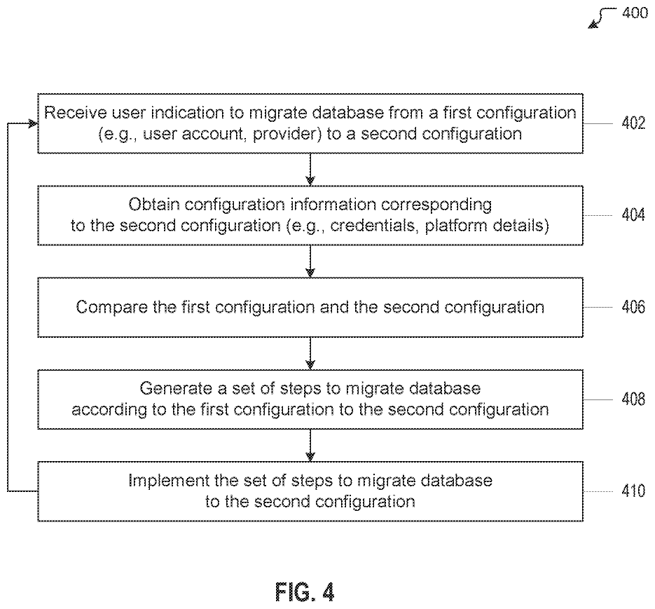

Accordingly, it will be appreciated that the change can relate to the configuration of the database, to an associated database engine, and/or to an associated platform, among other examples. For instance, the change includes a change to a database engine that is used to maintain the database (e.g., changing the database to a POSTGRES database from a MYSQL database). As another example, the change includes a change to a platform (e.g., changing the database from an AMAZON WEB SERVICES database to a MICROSOFT AZURE database). Additional examples of such aspects are discussed below with respect to method 400 in FIG. 4.

In examples, a user specifies a version in association with a target database state, such that the configuration of the database is maintained in accordance with the indicated version. In other examples, the user omits such a version indication, such that changes to the target database state result in an automatic upgrade of the database accordingly. As another example, an indication is generated and provided to a user (e.g., an administrator or a project manager), such that the user provides a confirmation indication in response, thereby causing the database to be upgraded accordingly. In instances where the database is upgraded (e.g., according to aspects of method 300), the upgrade can be performed in view of database usage, when a period of low activity has historically occurred or is otherwise expected to occur, and/or based on any of a variety of other considerations, thereby reducing the potential for downtime and/or a service interruption.

At operation 304, a current state configuration is determined for the database. Aspects of operation 304 may be similar to those discussed above with respect to operations 104 and/or 208 of methods 100 and 200, respectively. For example, an API associated with a database engine and/or a platform is queried to obtain the current state configuration accordingly. In such examples, a response to the query is received that includes one or more engine- and/or platform-specific configuration indications. As another example, one or more commands are executed to obtain such configuration indications accordingly. It will therefore be appreciated that any of a variety of techniques can be used to obtain a current state configuration for a database according to aspects described herein. Additionally, the configuration indications that form the target database state may be at a different (e.g., higher) level of abstraction as compared to the engine- and/or platform-specific configuration indications that are determined at operation 304.

At operation 306, the current state configuration and the target state configuration are compared, for example to identify one or more differences between the current state configuration and the target state configuration. Aspects of operation 306 may be similar to those discussed above with respect to operation 106 and/or 210 of methods 100 and 200.

Flow progresses to operation 308, where a set of steps is generated to transform the database from the current state configuration to the target state configuration (e.g., based on one or more differences that were identified at operation 306). Aspects of operation 308 may be similar to those discussed above with respect to operations 108 and/or 212 of methods 100 and 200. For example, a set of rules is evaluated, a set of templates is processed, and/or one or more steps are generated using a machine learning model, among other examples. As noted above, the generated set of steps may include one or more steps that are engine- and/or platform-specific (e.g., whereas the target state configuration generated at operation 206 need not be). Any of a variety of steps are generated at operation 308, which can, for example, include an API call, a command, and/or a reference to a configuration script, among other examples.

At operation 310, each step of the set of steps is processed, executed, or otherwise implemented, thereby configuring the database according to the target state configuration. Aspects of operation 310 may be similar to those discussed above with respect to operation 110 and/or 214 of methods 100 and 200. For instance, error handling is performed when implementing a given step and/or after the set of steps has been implemented, among other examples. As another example, the set of steps includes stopping the database and/or an associated database engine, upgrading a version associated with the database, starting the database and/or the associated database engine, waiting for the database to be available, and, in some examples, ultimately verifying that the database has been upgraded or otherwise reconfigured accordingly. In examples, method 300 forms part of a control loop, whereby changes to the configuration of the database are implemented by performing aspects of method 300 accordingly.

Although example method 300 has been shown using a selected group of processes, it will be appreciated that there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In certain examples, some or all processes (e.g., steps) of method 300 are performed by a computer and/or a processor directed by a code. For example, a computer includes a server computer and/or a client computer (e.g., a personal computer). In some examples, some or all processes (e.g., steps) of method 300 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

FIG. 4 is a simplified diagram showing an example method 400 for migrating a database from a first configuration to a second configuration according to certain embodiments of the present disclosure. This diagram is merely an example. One of ordinary skill in the art would recognize many variations, alternatives, and modifications.

As illustrated, at operation 402, a user indication is received to migrate the database from a first configuration to a second configuration. For example, the first configuration is associated with a current state configuration of the database, while the second configuration indicates a different user account, different database engine, and/or a different platform, among other examples. As another example, migration occurs across regions of the same platform or are performed from a platform to an on-premise or local installation. The first and second configurations can each be a different configuration or, as another example, the second configuration is an update to the first configuration.

Each configuration specifies a target database state for the database. In examples, at least a part of the first configuration is the same as or otherwise similar to the second configuration, as may be the case in instances where each configuration includes one or more general configuration indications. Thus, even though the configurations have different associated user accounts, different database engines, and/or different platforms, use of such general configuration indications offers a layer of abstraction through which more specific configuration indications may be abstracted away.

At operation 404, configuration information corresponding to the second configuration is obtained. For example, a user is prompted to provide authentication credentials (e.g., for a user account of the second configuration), platform details (e.g., an API key for a platform associated with the second configuration). As another example, a configuration file for the second configuration includes at least a part of such configuration information.

Flow progresses to operation 406, where the first configuration and the second configurations are compared, for example to identify one or more differences between the first and second configurations. Aspects of operation 406 may be similar to those discussed above with respect to operation 106, 210, and/or 306 of methods 100, 200, and 300, respectively. In examples, operation 406 comprises comparing specific configuration indications associated with the first and second configurations, as may have been determined from a respective set of general configuration indications for each configuration (e.g., aspects of which were discussed above with respect to operations 206 and 302 of methods 200 and 300).

At operation 408, a set of steps is generated to transform the database from the first configuration to the second configuration (e.g., based on one or more differences that were identified at operation 406). Aspects of operation 408 may be similar to those discussed above with respect to operations 108, 212, and/or 308 of methods 100, 200, and 300, respectively. For example, a set of rules is evaluated, a set of templates is processed, and/or one or more steps are generated using a machine learning model, among other examples. As noted above, according to certain embodiments, the generated set of steps includes one or more steps that are engine- and/or platform-specific (e.g., whereas the target state configuration generated at operation 206 need not be).

For instance, the set of steps includes initializing a new database associated with a new user account, a new database engine, and/or a new platform as indicated by the second configuration. The new database may be configured according to configuration indications of the second configuration. Accordingly, data can be migrated from the existing database (e.g., as may have been configured according to the first configuration) to the new database, thereby migrating the database accordingly. Finally, the set of steps includes, in some examples, archiving, dropping, or deleting the existing (and now unused) database.

Accordingly, at operation 410, each step of the set of steps is processed, executed, or otherwise implemented, thereby configuring the database according to the target state configuration. Aspects of operation 410 may be similar to those discussed above with respect to operation 110, 214, and/or 310 of methods 100, 200, and 300, respectively. For instance, error handling is performed when implementing a given step and/or after the set of steps has been implemented, among other examples. As another example, the set of steps includes stopping the database and/or an associated database engine associated with the first configuration, migrating the database according to the steps that were discussed above with respect to operation 408, starting the new database and/or the associated database engine, waiting for the new database to be available, and, in some examples, ultimately verifying that the new database has been migrated successfully. In examples, method 400 forms part of a control loop, whereby changes to the configuration of the database are implemented by performing aspects of method 400 accordingly.

Although example method 400 has been shown using a selected group of processes, it will be appreciated that there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In certain examples, some or all processes (e.g., steps) of method 400 are performed by a computer and/or a processor directed by a code. For example, a computer includes a server computer and/or a client computer (e.g., a personal computer). In some examples, some or all processes (e.g., steps) of method 400 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

It will be appreciated that aspects similar to the above-described methods can be used for any of a variety of other configuration changes (e.g., in addition to or as an alternative to those discussed above). For example, similar aspects are used for auto-scaling, in which a target database state is changed to indicate additional instances of the database should be created. Accordingly, in certain examples, a generated set of steps includes initializing one or more additional instances of the database (e.g., using the same or different platform and/or database engine as the existing database), determining how to distribute data among the existing instance and the new instance(s) (e.g., for redundancy and/or load balancing), and transferring at least a part of the data stored therein accordingly. Similarly, such auto-scaling may be performed automatically, for example as a result of determining that utilization of a first instance of a database has exceeded a predetermined threshold.

As illustrated, system 500 includes client computing device 502, management platform 504, service platform 506, and service platform 508. In examples, application 526 of client computing device 502 is used to provide a target database state, for example as a result of receiving user input to edit a configuration file and/or as a result of a user interacting with a conversational agent of management platform 504, among other examples.

Thus, in certain embodiments, request processor 510 receives a target database state for an existing database or for a new database, such as database 520 and/or database 524 (e.g., as may be hosted or otherwise provided be service platform 506 or service platform 508, respectively). Examples of such aspects were discussed above with respect to operations 102, 202, 302, and 402 of methods 100, 200, 300, and 400, respectively.

Accordingly, according to some examples, target state determiner 512 processes a target database state that is received from client computing device 502 to generate a target state configuration according to aspects described herein (e.g., as was discussed above with respect to operation 206 of method 200). For example, management platform 504 maintains a set of mappings between a given general configuration indication and one or more specific configuration indications, with which the target configuration state is generated accordingly.

Additionally, current state determiner 514 determines a current state configuration for a database associated with the target database state (e.g., database 520 and/or database 524). For example, current state determiner 514 generates a request to configuration API 518 and/or configuration API 522 of service platform 506 and/or 508, respectively, such that a current state configuration for each respective database is received accordingly. Examples of such aspects were discussed above with respect to operations 104, 208, 304, and 402 of methods 100, 200, and 300, respectively.

In examples, management platform 504 compares the current state configuration from current state determiner 514 and the target state configuration from target state determiner 512 according to aspects described herein. Examples of such aspects were discussed above with respect to operations 106, 210, 306, and 406 of methods 100, 200, 300, and 400, respectively.

Such aspects are performed by configuration implementation engine 516, in some examples, which generates and ultimately implements a set of steps with which to ultimately implement the target database state accordingly (e.g., aspects of which were discussed above with respect to operations 108-110, 212-214, 308-310, and 408-410 of methods 100, 200, 300, and 400, respectively). For example, management platform 504 processes one or more of the generated steps and/or communicates with service platform 506 and/or 508 via configuration API 518 and/or 522, respectively.

In some examples, management platform 504 further advertises information about one or more databases for which management platform 504 manages an associated configuration, thereby enabling other services to identify and/or use such databases accordingly. Additionally, or alternatively, management platform 504 restricts a user's ability to view or edit a target database state, such that application 526 is not usable by some users to edit an associated configuration.

While system 500 is illustrated as including one client computing device 502, one management platform 504, and two service platforms 506 and 508, it will be appreciated that any number of such elements may be used in other examples. Further, while example functionality is described in relation to specific elements of the illustrated system, it will be appreciated that, in other examples, such functionality may be distributed according to any of a variety of other paradigms.

In some cases, various components in system 500 can execute software or firmware stored in non-transitory computer-readable medium to implement various processing steps. Various components and processors of system 500 can be implemented by one or more computing devices including, but not limited to, circuits, a computer, a cloud-based processing unit, a processor, a processing unit, a microprocessor, a mobile computing device, and/or a tablet computer. In some cases, various components of system 500 can be implemented on a shared computing device. Alternatively, a component of system 500 can be implemented on multiple computing devices. In some implementations, various modules and components of system 500 can be implemented as software, hardware, firmware, or a combination thereof. In some cases, various components of system 500 can be implemented in software or firmware executed by a computing device.

Various components of system 500 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

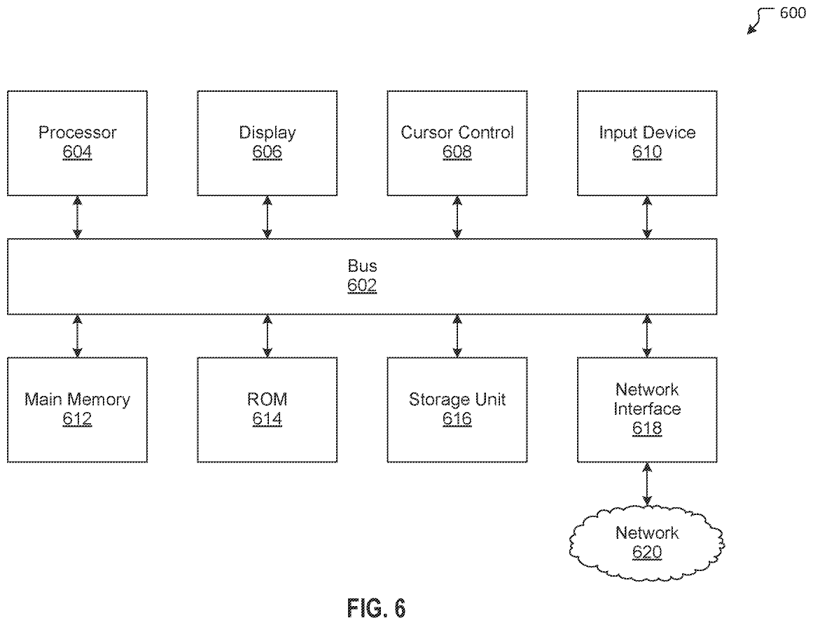

FIG. 6 is a simplified diagram showing a computing system for implementing a system 600 for database configuration management in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the method 100, the method 200, the method 300, and/or the method 400 are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For examples, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for managing a configuration of a database is provided. The method comprises: obtaining user input corresponding to a target database state for the database: generating, based on the user input, a target state configuration for the database: determining a current state configuration for the database; generating a set of steps to change the configuration of the database from the current state configuration to the target state configuration: and implementing the set of steps, thereby configuring the database according to the target state configuration: wherein the method is performed using one or more processors. For example, the method is implemented according to at least FIG. 1, FIG. 2, FIG. 3, and/or FIG. 4.

In an example, the obtaining user input comprises receiving, from the user, natural language input corresponding to the target database state. In another example, the obtaining user input further comprises prompting the user for additional natural language input corresponding to the target database state. In an example, the generating the target state configuration for the database comprises processing the natural language input using a large language model (LLM). In a further example, the generating a set of steps comprises evaluating the current state configuration and the target state configuration according to a set of rules to generate the set of steps. In yet another example, the generating a set of steps comprises processing the current state configuration and the target state configuration using a machine learning model to generate the set of steps. In a further still example, the generating, based on the user input, a target state configuration comprises identifying a pre-defined configuration that corresponds to a general configuration indication of the obtained user input.

According to some embodiments, another method for managing a configuration of a database is provided. The method comprises: obtaining a target database state for the database that includes a general configuration indication: generating a target state configuration for the database based on a pre-defined configuration that corresponds to the general configuration indication: determining a current state configuration for the database; generating a set of steps to change the configuration of the database from the current state configuration to the target state configuration: and implementing the set of steps, thereby configuring the database according to the target state configuration: wherein the method is performed using one or more processors. For example, the method is implemented according to at least FIG. 1, FIG. 2, FIG. 3, and/or FIG. 4.

In an example, the obtaining a target database state comprises: receiving, from the user, natural language input corresponding to the target database state: and prompting the user for additional natural language input corresponding to the target database state. In another example, the generating a set of steps comprises evaluating the current state configuration and the target state configuration according to a set of rules to generate the set of steps. In a further example, the generating a set of steps comprises processing the current state configuration and the target state configuration using a machine learning model to generate the set of steps. In yet another example, the set of steps is generated based on a mapping between the current state configuration to the target state configuration. In a further still example, the method further comprises evaluating the database to verify that the target state configuration has been achieved.

According to certain embodiments, a system for managing a configuration of a database is provided. The system comprises: one or more memories comprising instructions stored thereon: and one or more processors configured to execute the instructions and perform operations comprising: obtaining user input corresponding to a target database state for the database: generating, based on the user input, a target state configuration for the database: determining a current state configuration for the database: generating a set of steps to change the configuration of the database from the current state configuration to the target state configuration: and implementing the set of steps, thereby configuring the database according to the target state configuration. For example, the system is implemented according to at least the aspects described with respect to FIG. 1, FIG. 2, FIG. 3, and/or FIG. 4.

In an example, the obtaining user input comprises receiving, from the user, natural language input corresponding to the target database state. In another example, the obtaining user input further comprises prompting the user for additional natural language input corresponding to the target database state. In a further example, the generating the target state configuration for the database comprises processing the natural language input using a large language model (LLM). In yet another example, the generating a set of steps comprises evaluating the current state configuration and the target state configuration according to a set of rules to generate the set of steps. In a further still example, the generating a set of steps comprises processing the current state configuration and the target state configuration using a machine learning model to generate the set of steps. In another example, the generating, based on the user input, a target state configuration comprises identifying a pre-defined configuration that corresponds to a general configuration indication of the obtained user input.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be removed from the combination, and a combination may, for example, be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for managing a configuration of a database, the method comprising:
obtaining user input corresponding to a target database state for the database;
generating, based on the user input, a target state configuration for the database;
determining a current state configuration for the database;
generating a set of steps to change the configuration of the database from the current state configuration to the target state configuration; and
implementing the set of steps, thereby configuring the database according to the target state configuration;
wherein the method is performed using one or more processors.

2. The method of claim 1, wherein the obtaining user input comprises receiving, from the user, natural language input corresponding to the target database state.

3. The method of claim 2, wherein the obtaining user input further comprises prompting the user for additional natural language input corresponding to the target database state.

4. The method of claim 3, wherein the generating the target state configuration for the database comprises processing the natural language input using a large language model (LLM).

5. The method of claim 1, wherein the generating a set of steps comprises evaluating the current state configuration and the target state configuration according to a set of rules to generate the set of steps.

6. The method of claim 1, wherein the generating a set of steps comprises processing the current state configuration and the target state configuration using a machine learning model to generate the set of steps.

7. The method of claim 1, wherein the generating, based on the user input, a target state configuration comprises identifying a pre-defined configuration that corresponds to a general configuration indication of the obtained user input.

8. A method for managing a configuration of a database, the method comprising:
obtaining a target database state for the database that includes a general configuration indication;
generating a target state configuration for the database based on a pre-defined configuration that corresponds to the general configuration indication;
determining a current state configuration for the database;
generating a set of steps to change the configuration of the database from the current state configuration to the target state configuration; and
implementing the set of steps, thereby configuring the database according to the target state configuration;
wherein the method is performed using one or more processors.

9. The method of claim 8, wherein the obtaining a target database state comprises:
receiving, from the user, natural language input corresponding to the target database state; and
prompting the user for additional natural language input corresponding to the target database state.

10. The method of claim 8, wherein the generating a set of steps comprises evaluating the current state configuration and the target state configuration according to a set of rules to generate the set of steps.

11. The method of claim 8, wherein the generating a set of steps comprises processing the current state configuration and the target state configuration using a machine learning model to generate the set of steps.

12. The method of claim 8, wherein the set of steps is generated based on a mapping between the current state configuration to the target state configuration.

13. The method of claim 8, further comprising evaluating the database to verify that the target state configuration has been achieved.

14. A system for managing a configuration of a database, the system comprising:
one or more memories comprising instructions stored thereon; and
one or more processors configured to execute the instructions and perform operations comprising:
obtaining user input corresponding to a target database state for the database;
generating, based on the user input, a target state configuration for the database:
determining a current state configuration for the database;
generating a set of steps to change the configuration of the database from the current state configuration to the target state configuration; and
implementing the set of steps, thereby configuring the database according to the target state configuration.

15. The system of claim 14, wherein the obtaining user input comprises receiving, from the user, natural language input corresponding to the target database state.

16. The system of claim 15, wherein the obtaining user input further comprises prompting the user for additional natural language input corresponding to the target database state.

17. The system of claim 16, wherein the generating the target state configuration for the database comprises processing the natural language input using a large language model (LLM).

18. The system of claim 14, wherein the generating a set of steps comprises evaluating the current state configuration and the target state configuration according to a set of rules to generate the set of steps.

19. The system of claim 14, wherein the generating a set of steps comprises processing the current state configuration and the target state configuration using a machine learning model to generate the set of steps.

20. The system of claim 14, wherein the generating, based on the user input, a target state configuration comprises identifying a pre-defined configuration that corresponds to a general configuration indication of the obtained user input.
